(19) United States
(12) Patent Application Publication
(10) Pub. No.: US 2013/0297181 A1
(43) Pub. Date: Nov. 7, 2013

(54) ADAPTIVE ENGINE CONTROL IN RESPONSE TO A BIODIESEL FUEL BLEND

(71) Applicants: Yue-Yun Wang, Troy, MI (US); Ibrahim Haskara, Macomb, MI (US); Claudio Ciaravino, Torino (IT); Alberto Vassallo, Torino (IT)

(72) Inventors: Yue-Yun Wang, Troy, MI (US); Ibrahim Haskara, Macomb, MI (US); Claudio Ciaravino, Torino (IT); Alberto Vassallo, Torino (IT)

(73) Assignee: GM GLOBAL TECHNOLOBY OPERATIONS LLC, Detroit, MI (US)

(21) Appl. No.: 13/463,884

(22) Filed: May 4, 2012

(51) Int. Cl. F02D 41/26; F02D 41/30

(52) U.S. Cl. 701/103

(57) ABSTRACT

A method for operating a compression-ignition engine includes controlling an engine fueling, a compressor boost pressure, and an EGR content in a cylinder charge to maintain engine operation in response to a biodiesel blend ratio of a biodiesel fuel blend.

### TECHNICAL FIELD

This disclosure is related to control of an engine using a biodiesel fuel blend.

### BACKGROUND

The statements in this section merely provide background information related to the present disclosure. Accordingly, such statements are not intended to constitute an admission of prior art.

Known internal combustion engines may be configured to operate with compression-ignition (CI) combustion, and are often referred to as diesel or CI engines. CI engines employ fuel that may be derived from petroleum or vegetable oil and animal fat stocks. Fuel derived from petroleum includes long-chain hydrocarbon molecules and is referred herein as diesel fuel. Fuel derived from vegetable oil or animal fat stocks includes long-chain alkyl esters and is referred to herein as biodiesel fuel. CI engines can operate on a 100% diesel fuel. Additionally, CI engines can be configured to operate partially or fully on a biodiesel fuel. A biodiesel blend ratio can be identified. BO fuel is identified as a 100% diesel fuel. 100% BV fuel is identified as 100% biodiesel fuel. xx % BV fuel can be identified as a fuel composition including x % biodiesel fuel and (100%−x %) diesel fuel. For example, 40% BV fuel has a fuel composition including 40% biodiesel fuel and 60% diesel fuel.

Diesel fuel and biodiesel fuel have different physical and chemical properties. Diesel fuel has a higher energy density than biodiesel fuel, whereas biodiesel fuel has higher oxygen content than diesel fuel. As a result, a greater mass of biodiesel fuel must be injected than of diesel fuel under the same circumstances in order to achieve similar combustion characteristics. Injected fuel mass for combustion can be adjusted in response to the biodiesel blend ratio. Further, when fuel is used for purposes other than combustion within the engine, injected fuel mass must be adjusted based upon the biodiesel blend ratio.

Fuel cetane numbers indicate the readiness of a fuel to auto-ignite as measured at in-cylinder temperatures and pressures. One known method of measuring cetane number is ASTM D613. Known CI engines operate with a cetane number between 40 and 55. Diesel fuel blended to meet ASTM D975 has a minimum cetane number of 40, with typical values in the 42-45 range. Biodiesel fuel blended according to ASTM D6751 has a minimum cetane number of 40. Biodiesel fuel from vegetable oil has a cetane number range of 46 to 52, and animal-fat-based biodiesels have a cetane number range of 56 to 60. Thus, ignition timing of a cylinder charge may be affected by the biodiesel blend ratio.

One non-combustion use of fuel includes regeneration of a lean NOx trap (LNT). NOx is a component of an exhaust gas flow generated by the engine during combustion. Aftertreatment devices are known to treat NOx within the exhaust gas flow, converting the NOx into other substances to be expelled with the exhaust. A LNT stores NOx molecules during lean engine operations and releases and reduces the stored NOx during rich engine operations. Known LNTs have a finite NOx storage capacity and require periodic regeneration, which may include a fuel rich pulse. It is desirable to control regeneration events to provide emission control and minimize fuel consumption.

### SUMMARY

A method for operating a compression-ignition engine includes controlling an engine fueling, a compressor boost pressure, and an EGR content in a cylinder charge to maintain engine operation in response to a biodiesel blend ratio of a biodiesel fuel blend.

### BRIEF DESCRIPTION OF THE DRAWINGS

One or more embodiments will now be described, by way of example, with reference to the accompanying drawings, in which:

FIG. 1 illustrates an exemplary internal combustion engine, control module, and exhaust aftertreatment system, in accordance with the present disclosure;

FIGS. 2-1 through 2-6 illustrate effects upon engine control parameters that are necessary to maintain engine torque with changes in the biodiesel blend ratio in the engine fuel in accordance with the disclosure;

FIG. 3 illustrates a method in the form of an adaptive engine control scheme for controlling operation of an exemplary engine 10 that is responsive to fuel that may include a biodiesel blend ratio, wherein the magnitude of the biodiesel blend ratio may vary during operation and during the service life of the engine in accordance with the disclosure;

FIG. 4 illustrates a flowchart associated with the fueling subroutine 120 in accordance with the disclosure;

FIG. 5-1 illustrates an embodiment of the adaptive EGR controller 150 for generating the EGR control signal 33 in accordance with the disclosure;

FIG. 5-2 illustrates an embodiment of the adaptive MAF controller 150 for generating the ETC control signal 15 in accordance with the disclosure;

FIG. 5-3 illustrates an embodiment of the adaptive fuel rail pressure controller 170 for generating the fuel pressure control signal 53 in accordance with the disclosure;

FIG. 5-4 illustrates an embodiment of the boost controller for generating the compressor boost command taking into account compressor surge and the blend volume of the fuel in accordance with the disclosure; and

FIG. 5-5 illustrates a portion of a second embodiment of the boost controller shown with reference to FIG. 5-4, including a second embodiment of the surge line function in accordance with the disclosure.

### DETAILED DESCRIPTION

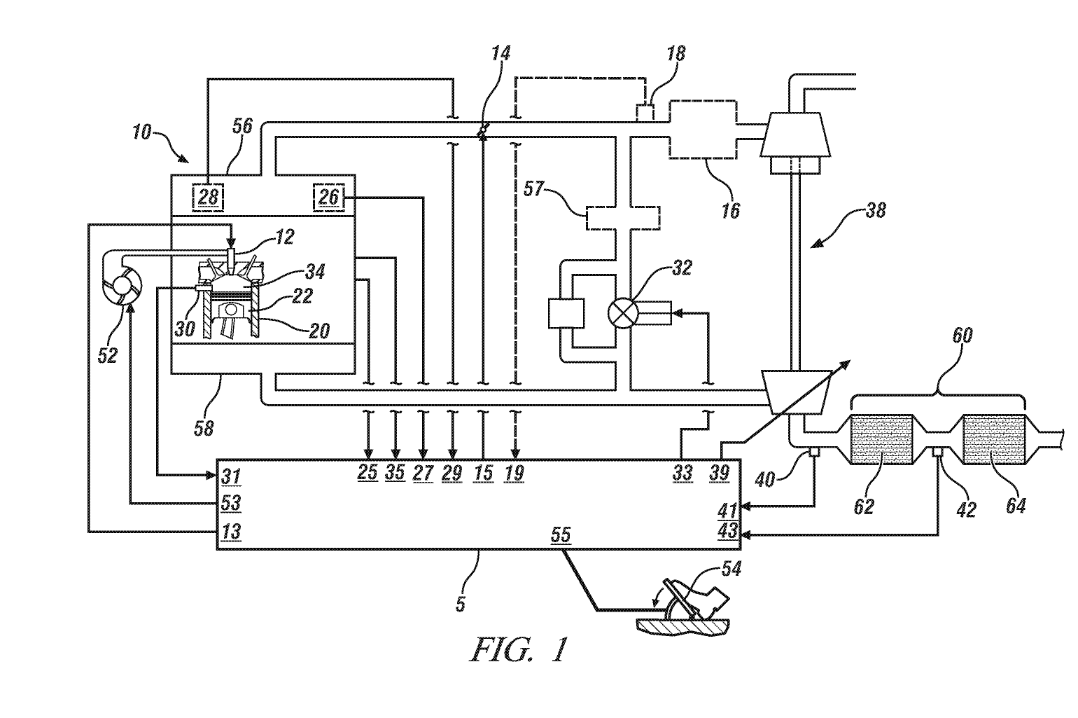

Referring now to the drawings, wherein the showings are for the purpose of illustrating certain exemplary embodiments only and not for the purpose of limiting the same, FIG. 1 illustrates an exemplary internal combustion engine 10, control module 5, and exhaust aftertreatment system 60. The exemplary CI engine 10 is a multi-cylinder, direct-injection, compression-ignition internal combustion engine including an intake manifold 56 and an exhaust manifold 58, and having reciprocating pistons 22 attached to a crankshaft and movable in cylinders 20 which define variable volume combustion chambers 34. The crankshaft may be attached to a vehicle transmission and driveline to deliver tractive torque thereto in response to an output torque request. The CI engine 10 preferably employs a four-stroke operation wherein each engine combustion cycle includes 720° of angular rotation of the crankshaft divided into four 180° stages of reciprocating movement of the piston 22 in the engine cylinder 20. Each variable volume combustion chamber 34 is defined between the piston 22, the cylinder 20, and a cylinder head as the piston 22 translates in the cylinder 20 between top-dead-center and bottom-dead-center points. The cylinder head includes intake valves and exhaust valves. The CI engine 10 preferably operates in a four-stroke combustion cycle that includes intake, compression, expansion, and exhaust strokes. It is appreciated that the concepts described herein apply to other combustion cycles. The CI engine 10 preferably operates at a lean air/fuel ratio. The exhaust aftertreatment system 60 fluidly couples to the exhaust manifold 58, and preferably includes an oxidation catalyst 62 fluidly upstream of a particulate filter 64. The particulate filter 64 may be catalyzed. The exhaust aftertreatment system 60 may include other components and sensors. The disclosure is applicable to other engine configurations that employ some form of biofuel including engine configurations that operate at lean conditions and generate particulate matter, including lean-burn spark-ignition engines. The disclosure is applicable to powertrain systems that employ internal combustion engines in combination with transmission devices to generate tractive torque, including by way of example engine-transmission systems and hybrid powertrain systems employing non-combustion torque generative motors.

The engine 10 includes sensors to monitor engine operation, and actuators which control engine operation. The sensors and actuators are signally and operatively connected to control module 5. The actuators are installed on the engine and controlled by the control module 5 in response to operator inputs to achieve various performance goals. A fuel injection system including a plurality of direct-injection fuel injectors 12 fluidly coupled either directly or via a common-rail fuel distribution system to a pressurized fuel distribution system including a high-pressure fuel pump 52. The fuel pump 52 may be controlled to control fuel pressure 53. The fuel injectors 12 directly inject fuel into each of the combustion chambers 34 to form a cylinder charge in response to an injector control signal 13 from the control module 5. The fuel injectors 12 are individually supplied with pressurized fuel, and have operating parameters including a minimum pulsewidth and an associated minimum controllable fuel flow rate, and a maximum fuel flow rate. An exhaust gas recirculation (EGR) system includes a flow channel for directing flow of externally recirculated exhaust gas between the exhaust manifold 58 and the intake manifold 56, an intercooler 57 and an EGR valve 32 that is controlled via control signal 33 from the control module 5. An intake air compressor system 38 is configured to control flow of intake air to the engine 10 in response to a compressor boost command 39. The intake air compressor system 38 boosts a supply of intake air into the engine to increase engine mass airflow and thus increase engine power, including increasing intake air pressure to greater than ambient pressure. In one embodiment the intake air compressor system 38 is a variable-geometry turbocharger (VGT) system that includes a turbine device located in the exhaust gas stream rotatably coupled to a compressor device that is configured to increase flow of engine intake air. Alternatively, the intake air compressor system 38 may include a supercharger device or another turbocharger device. An air intercooler device 16 may be fluidly located between the intake air compressor 38 and the engine intake manifold 56. An electronically-controlled throttle valve 14 controls throttle opening and thus flow of intake air into the intake system of the engine in response to a throttle control signal (ETC) 15. A glow-plug may be installed in each of the combustion chambers 34 for increasing in-cylinder temperature during engine starting events at cold ambient temperatures. The engine 10 may be equipped with a controllable valvetrain configured to adjust openings and closings of intake and exhaust valves of each of the cylinders, including any one or more of valve timing, phasing (i.e., timing relative to crank angle and piston position), and magnitude of lift of valve openings.

The sensors described herein are configured to monitor physical characteristics and generate signals that correlate to engine, exhaust gas, and ambient parameters. A crank sensor interacts with a multi-tooth target wheel attached to the crankshaft to monitor engine crank position and engine speed (RPM) 25. A combustion pressure sensor 30 is configured to monitor cylinder pressure 31, from which a mean-effective pressure or another suitable combustion parameter may be determined. The combustion pressure sensor 30 may be non-intrusive, including a force transducer having an annular cross-section that is installed into the cylinder head at an opening for a glow-plug and having an output signal that is proportional to cylinder pressure. The pressure sensor 30 includes a piezo-ceramic or other suitable monitoring device. A mass air flow (MAF) sensor 18 monitors mass air flow 19 of fresh intake air. A coolant sensor 36 monitors engine coolant temperature 35. A manifold absolute pressure (MAP) sensor 26 monitors intake manifold absolute pressure 27 and ambient barometric pressure. A manifold air temperature (MAT) sensor 28 monitors intake manifold air temperature 29. Exhaust gas sensors 40 and 42 monitor states 41 and 43 respectively, of one or more exhaust gas parameters, e.g., air/fuel ratio, and exhaust gas constituents, and may be used as feedback for control and diagnostics. Other sensors and monitoring schemes may be employed for purposes of control and diagnostics. Operator input in the form of an output torque request 55 may be obtained through an operator interface system 54 that preferably includes an accelerator pedal and a brake pedal, among other devices. Each of the aforementioned sensors is signally connected to the control module 5 to provide signal information which is transformed to information representative of the respective monitored parameter. It is understood that this configuration is illustrative, not restrictive, including the various sensors being replaceable with functionally equivalent devices and algorithms.

The control module 5 executes routines stored therein to control the aforementioned actuators to control engine operation, including throttle position, fuel injection mass and timing, EGR valve position to control flow of recirculated exhaust gases, compressor boost, glow-plug operation, and control of intake and/or exhaust valve timing, phasing, and lift on systems so equipped. The control module 5 is configured to receive the operator inputs 54 to determine the output torque request 55 and receive signal inputs from the aforementioned sensors to monitor engine operation and ambient conditions. The engine 10 is configured to generate output torque in response to the output torque request 55, including operating over a broad range of temperatures, cylinder charge (air, fuel, and EGR) and injection events. The methods described herein are particularly suited to application on direct-injection compression-ignition engines operating lean of stoichiometry.

Control module, module, control, controller, control unit, processor and similar terms mean any suitable one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or routines, combinational logic circuit(s), input/output circuit(s) and devices, appropriate signal conditioning and buffer circuitry, and other suitable components to provide the described functionality. Software, firmware, programs, instructions, routines, code, algorithms and similar terms mean any controller executable instruction sets including calibrations and look-up tables. The control module 5 has a set of control routines executed to provide the desired functions. The routines are preferably executed during preset loop cycles. Routines are executed, such as by a central processing unit, and are operable to monitor inputs from sensing devices and other networked control modules, and execute control and diagnostic routines to control operation of actuators. Loop cycles may be executed at regular intervals, for example each 3.125, 6.25, 12.5, 25 and 100 milliseconds during ongoing engine and vehicle operation. Alternatively, routines may be executed in response to occurrence of an event.

FIGS. 2-1 through 2-6 graphically show effects upon engine control parameters that are necessary to maintain engine torque with changes in the biodiesel blend ratio in the engine fuel. The results demonstrate effects of changes in the biodiesel blend ratio without changes in respective engine control parameters. Lower heating value (LHV) of biodiesel differs from LHV of diesel fuel. The difference in LHV affects engine power generation, and varies with the biodiesel blend ratio. Specific engine operation and engine control elements are affected by the biodiesel blend ratio. The depicted biodiesel blend ratio metric is based upon volume, and is a volumetric ratio of biodiesel fuel in relation to total fuel volume, including of 0% BV (pure diesel fuel) 201, 10% BV 203, 30% BV 205, 50% BV 207, and 100% BV (pure biodiesel fuel) 209. Energy content of fuel, which is indicated by a heating value index, e.g., LHV, decreases with an increase in the biodiesel blend ratio.

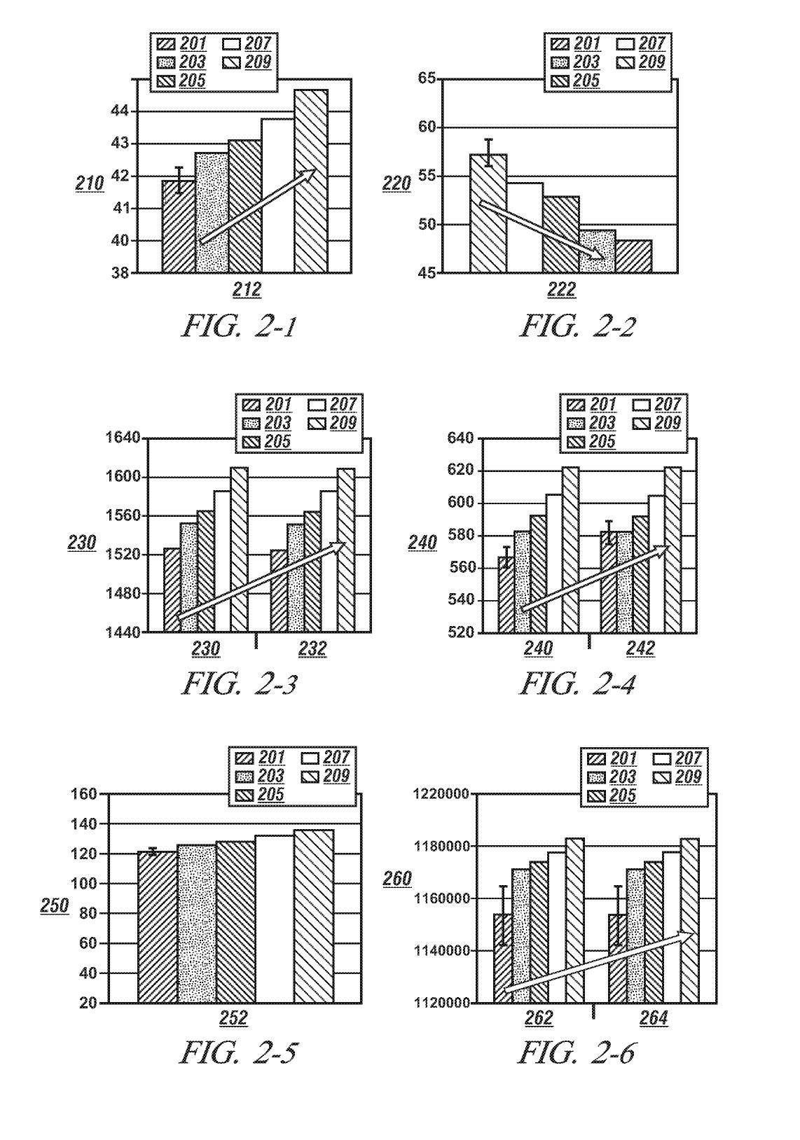

FIG. 2-1 shows accelerator pedal position 210 (%-open) required to maintain the engine torque point constant for biodiesel blend ratios of 0% BV (pure diesel fuel) 201, 10% BV 203, 30% BV 205, 50% BV 207, and 100% BV (pure biodiesel fuel) 209. The data indicate that throttle position must increase to maintain a constant engine torque with increasing biodiesel blend ratios.

FIG. 2-2 shows EGR duty cycle (%-open) 220 required based on the increased throttle position to maintain the engine torque point at a constant level for biodiesel blend ratios of 0% BV (pure diesel fuel) 201, 10% BV 203, 30% BV 205, 50% BV 207, and 100% BV (pure biodiesel fuel) 209. The EGR duty cycle is determined in response to the accelerator pedal position, and is affected by an increase to the accelerator pedal position from the operator to maintain output torque. The data indicate that the EGR flow command decreases to maintain a constant engine torque with increasing biodiesel blend ratios resulting in increased engine-out NOx emissions unless there is some form of compensation or adjustment.

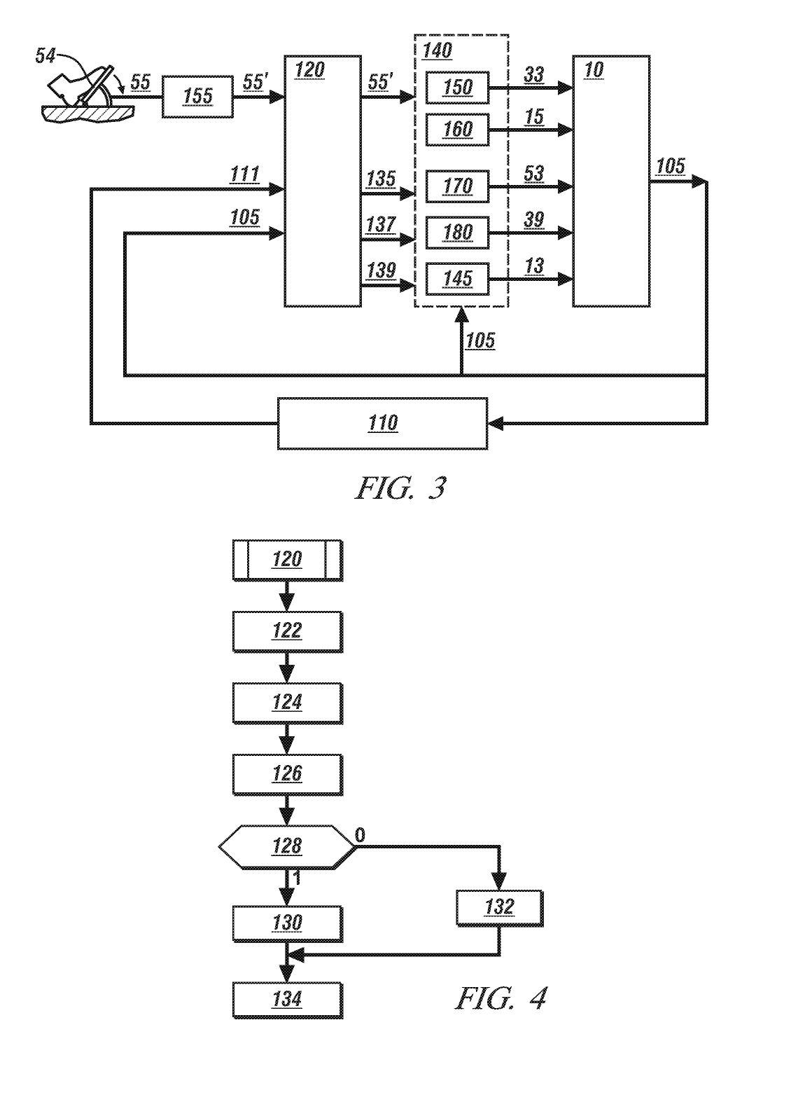

FIG. 2-3 shows boost pressure setpoint (kPa) 230 and actual boost pressure (kPa) 232 required to maintain the engine torque point at a constant level for biodiesel blend ratios of 0% BV (pure diesel fuel) 201, 10% BV 203, 30% BV 205, 50% BV 207, and 100% BV (pure biodiesel fuel) 209. The boost pressure setpoint is determined in response to the accelerator pedal position, and is affected by an increase to the accelerator pedal position from the operator to maintain output torque. The data indicate that boost pressure increases to maintain a constant engine torque with increasing biodiesel blend ratios.

FIG. 2-4 shows a mass airflow setpoint (mg) 240 and an actual intake air mass (mg) 242 required to maintain a constant engine torque point for biodiesel blend ratios of 0% BV (pure diesel fuel) 201, 10% BV 203, 30% BV 205, 50% BV 207, and 100% BV (pure biodiesel fuel) 209. The mass airflow setpoint is determined in response to the accelerator pedal position, and is affected by an increase to the accelerator pedal position from the operator to maintain output torque. The data indicate that intake air mass increases in response to the increased throttle position to maintain a constant engine torque with increasing biodiesel blend ratios.

FIG. 2-5 shows actual engine torque (Nm) 250 after adjustment the accelerator pedal position in response to biodiesel blend ratios of 0% BV (pure diesel fuel) 201, 10% BV 203, 30% BV 205, 50% BV 207, and 100% BV (pure biodiesel fuel) 209.

FIG. 2-6 shows a fuel rail pressure setpoint (MPa) 260 and an actual fuel rail pressure (MPa) 262 required to maintain a constant engine torque point for biodiesel blend ratios of 0% BV (pure diesel fuel) 201, 10% BV 203, 30% BV 205, 50% BV 207, and 100% BV (pure biodiesel fuel) 209. The data indicate that fuel rail pressure must increase to maintain a constant engine torque with increasing biodiesel blend ratios.

FIG. 3 shows an adaptive engine control scheme for controlling operation of an embodiment of the engine 10 that is responsive to a biodiesel fuel blend, wherein the magnitude of the biodiesel blend ratio of the engine fuel may vary during operation and during the service life of the engine 10. The biodiesel blend ratio affects the lower heating value and stoichiometric air/fuel ratio of the engine fuel. The adaptive engine control scheme controls engine combustion in response to the lower heating value and stoichiometric air/fuel ratio of the fuel. This includes adjusting contents of a cylinder charge and managing compressor boost to account for changes in energy and oxygen content of the biodiesel fuel blend. The adaptive engine control scheme employs a plurality of adaptive control algorithms to control engine fueling, boost pressure, rail pressure, EGR % and MAF control to maintain engine torque output, engine and combustion noise, and exhaust emissions levels in response to the energy and oxygen content of the biodiesel fuel blend. The adaptive engine control scheme includes a blend ratio subroutine 110, a fueling subroutine 120, and an adaptive controller 140 that are employed to determine control parameters for operating the engine 10, including adapting engine operation in response to the biodiesel blend ratio 111, taking into consideration the output torque request 55 and engine operating parameters 105.

The blend ratio subroutine 110 is executed to determine a magnitude of the biodiesel blend ratio 111 using suitable monitoring and analytical schemes. A first exemplary method to determine a biodiesel blend ratio based upon an exhaust oxygen fraction and an air/fuel ratio is disclosed in co-pending and commonly assigned U.S. Ser. No. 13/113,177 (Attorney Docket No. P014873), which is incorporated herein by reference. A second exemplary method to determine the biodiesel blend ratio based upon an in-cylinder pressure is disclosed in co-pending and commonly assigned U.S. Ser. No. 12/850,122 (Attorney Docket No. P009553), which is incorporated herein by reference. By directly determining the biodiesel blend ratio, properties of the engine fuel can be estimated or determined from look-up values. The biodiesel blend ratio may be calculated as a volumetric blend ratio or another suitable ratio.

The fueling subroutine 120 uses the output torque request 55, the biodiesel blend ratio 111, and the engine operating parameters 105 to determine and generate outputs including fuel parameters associated with the biodiesel blend ratio 135, a base fueling command 137 and an adjusted fueling command 139, which are provided as inputs to the adaptive controller 140. An engine torque determination scheme 155 analyzes the output torque request 55 to determine an engine torque request 55′. When the powertrain system employs the engine 10 as a single torque-generative device that is coupled to a fixed-gear transmission device, the engine torque request 55′ is set equal to the output torque request 55. When the powertrain system employs the engine 10 as one of a plurality of torque-generative devices that generate tractive torque in response to the output torque request 55 (e.g., in a hybrid powertrain system), the engine torque request 55′ may differ from the output torque request 55, with additional torque generated using other torque-generative devices, e.g., electric motor/generators. The base fueling command 137 is determined in response to the engine torque request 55′, and is an engine fueling command that is determined based upon an amount of 0% BV diesel fuel required to generate engine torque to meet the engine torque request 55′. The base fueling command 137 is adjusted to the adjusted fueling command 139 based upon a lower heating value of the fuel blend, wherein the lower heating value of the fuel blend is determined based upon the biodiesel blend ratio 111.

FIG. 4 schematically shows a flowchart associated with the fueling subroutine 120. Table 1 is provided as a key wherein the numerically labeled blocks and the corresponding functions are set forth as follows.

TABLE 1

| BLOCK | BLOCK CONTENTS |
|---|---|
| 120 | Fueling subroutine to adapt engine operation in response to |
| | biodiesel blend ratio |
| 122 | Monitor engine parameters and engine torque request |
| 124 | Determine fuel parameters corresponding to BV, including |
| | AFR_{stRD}/AFR_{stBD}, LHV_{RD}/LHV_{BD} |
| 126 | Calculate Fbase in response to engine torque request and |
| | engine parameters |
| 128 | Is BV > BVthr? |
| 130 | Fadj = Fbase * (LHVrd/LHVbd) |
| 132 | Fadj = Fbase |
| 134 | Return |

In operation the fueling subroutine 120 is employed to adapt engine operation in response to the biodiesel blend ratio. The engine torque request 55′, the biodiesel blend ratio 111 and engine parameters 105 are periodically monitored. The engine parameters 105 preferably include MAF 19, MAP 27, MAT 29, cylinder pressure 31, RPM 25, coolant temperature 35, and exhaust gas parameters 41 of air/fuel ratio, NOx, and/or others (122).

Fuel parameters corresponding to the biodiesel blend ratio (BV) 111 of the engine fuel are determined (124). The primary fuel parameter of interest is a fuel heating value ratio (LHV_{RD}/LHV_{BD}), which is a ratio of the energy content of diesel fuel, i.e., 0% BV (LHV_{BD}), in relation to the energy content of the biodiesel fuel blend (LHV_{BD}) with which the engine 10 is presently operating. The fuel heating value ratio may be determined based upon cylinder pressure. Alternatively, the fuel heating value ratio may be determined by monitoring exhaust gas air/fuel ratio and intake air flow, determining a stoichiometric air/fuel ratio of the biodiesel fuel blend, and determining the fuel heating value ratio based upon a ratio of a stoichiometric air/fuel ratio of 0% BV diesel fuel (RD) and the stoichiometric air/fuel ratio of the biodiesel fuel blend BD, hereinafter referred to as a ratio of stoichiometric air/fuel combustion (AFR_{stRD}/AFR_{stBD}). Such methods are known to persons having ordinary skill in the art.

A base engine fueling (Fbase) is calculated in response to the engine torque request 55′ and the aforementioned engine parameters (126). The base engine fueling (Fbase) is a measure of the amount of 0% BV diesel fuel to deliver to the engine to generate torque that is responsive to the engine torque request 55′ taking into account the engine operating parameters 105.

It is determined whether the biodiesel blend ratio (BV) is greater than a threshold blend ratio (BVthr) (128). When the biodiesel blend ratio is less than the threshold blend ratio, the effect of the biodiesel fuel blend upon engine operation is considered relatively minor, and adaptive engine control is not employed (0). Instead, the adjusted engine fueling (Fadj) is set equal to the base engine fueling (Fbase) (132). When the biodiesel blend ratio is greater than the threshold blend ratio (128) (1), the effect of the biodiesel fuel blend upon engine operation is considered sufficient to employ adaptive engine control. The threshold blend ratio BVthr may be any suitable value that accounts for the effect of the biodiesel fuel blend upon engine operation, especially engine output power in response to the engine torque request 55′. In one embodiment the threshold blend ratio BVthr may be 30% BV. Alternatively the threshold blend ratio BVthr may be near 25% BV. The adjusted engine fueling (Fadj) is calculated by multiplying the base engine fueling (Fbase) and the fuel heating value ratio (LHV_{RD}/LHV_{BD}). The adjusted engine fueling may be limited to a maximum value, regardless of the magnitude of the fuel heating value ratio. The fueling subroutine 120 returns control parameters for use by the adaptive controller 140. The preferred control parameters include the engine torque request 55′, the base engine fueling (Fbase) 137, the adjusted engine fueling (Fadj) 139, and fuel parameters 135 including the heating value ratio (LHV_{RD}/LHV_{BD}) and the ratio of stoichiometric air/fuel combustion (AFR_{stRD}/AFR_{stBD}) (134).

The adaptive controller 140 adjusts fuel and EGR content of a cylinder charge and manages compressor boost in response to a biodiesel fuel blend. The adaptive controller includes an adaptive EGR controller 150, an adaptive MAF controller 160, an adaptive fuel rail pressure controller 170, a boost controller 180, and a fuel injection controller 145. As described herein, the adaptive EGR controller 150 generates EGR control signal 33, the adaptive MAF controller 160 generates ETC control signal 15, the adaptive fuel rail pressure controller 170 generates fuel pressure control signal 53, the boost controller 180 generates compressor boost command 39, and the fuel injection controller 145 generates the injector control signal 13. The fuel injection controller 145 employs the adjusted fueling command 139 to determine the injector command 13 including fuel injection timing and pulsewidth commands to deliver a mass of fuel into the combustion chamber 34 in response to the engine torque request 55′, taking into account the fuel pressure control signal 53, the aforementioned fuel parameters 135, and the various engine operating parameters 105. As previously stated, the base fueling command 137 is adjusted to the adjusted fueling command 139 based upon the heating value of the biodiesel fuel blend, wherein the heating value of the biodiesel fuel blend is determined based upon the biodiesel blend ratio 111.

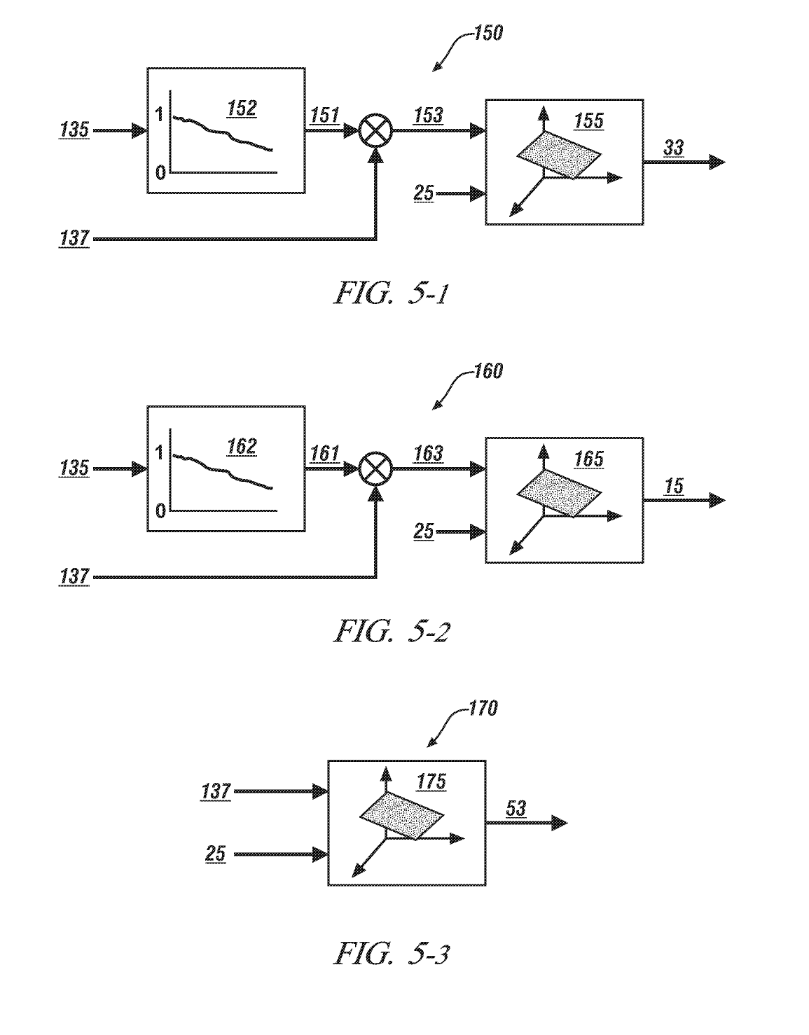

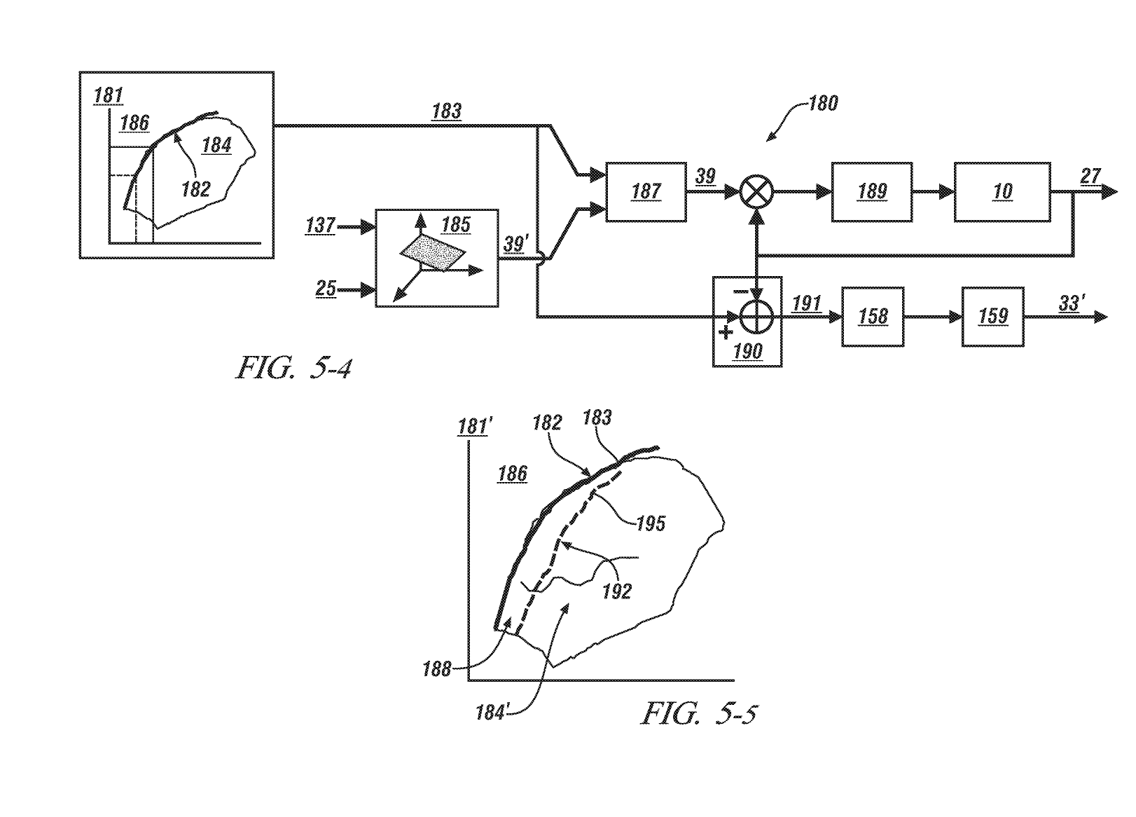

FIG. 5-1 schematically shows an embodiment of the adaptive EGR controller 150 for generating the EGR control signal 33. The fuel parameter 135 of the ratio of stoichiometric air/fuel combustion (AFR_{stRD}/AFR_{stBD}) is employed by an EGR modifier calibration 152 to determine an EGR modifier 151. The EGR modifier calibration 152 compensates for extra oxygen content in unburned biodiesel fuel through the EGR. The EGR modifier has a value of 1.0 for 0% BV diesel fuel, and progressively reduces from 1.0 to a relatively low magnitude, e.g., 0.05 as the ratio of stoichiometric air/fuel combustion (AFR_{stRD}/AFR_{stBD}) increases with an increase in the biodiesel fuel blend. This calibration is intended to decrease EGR % in a cylinder charge with an increase in the biodiesel fuel blend. The EGR modifier 151 is multiplied with the base fueling command 137 to determine a modified fuel command 153. An EGR calibration table 155 generates the EGR control signal 33, which is a preferred EGR rate for the modified fuel command 153 at the present engine speed 25. The EGR calibration table 155 is developed using the engine 10 operating with 0% BV diesel fuel using calibration processes known to persons having ordinary skill in the art. Thus, EGR rate (i.e., the EGR % for a cylinder charge) decreases with an increase in the biodiesel fuel blend in order to maintain engine-out NOx emissions at known levels.

FIG. 5-2 schematically shows an embodiment of the adaptive MAF controller 150 for generating the ETC control signal 15. The fuel parameter 135 of the ratio of stoichiometric air/fuel combustion (AFR_{stRD}/AFR_{stBD}) is employed by a MAF modifier calibration 162 to determine a MAF modifier 161. The MAF modifier has a value of 1.0 for 0% BV diesel fuel, and progressively reduces from 1.0 to a relatively low magnitude, e.g., 0.05 as the ratio of stoichiometric air/fuel combustion (AFR_{stRD}/AFR_{stBD}) increases with an increase in the biodiesel fuel blend. This calibration is intended to decrease mass of intake air in a cylinder charge with an increase in the biodiesel fuel blend. The MAF modifier 161 is multiplied with the base fueling command 137 to determine a modified fuel command 153. An MAF calibration table 165 generates the ETC control signal 15, which is associated with a preferred MAF for the modified fuel command 163 at the present engine speed 25. The MAF calibration table 165 is developed using the engine 10 operating with 0% BV diesel fuel and employing calibration processes known to persons having ordinary skill in the art. Thus, intake air (i.e., fresh air charge for a cylinder charge) decreases with an increase in the biodiesel fuel blend in order to maintain or reduce engine-out NOx emissions.

FIG. 5-3 schematically shows an embodiment of the adaptive fuel rail pressure controller 170 for generating the fuel pressure control signal 53. A fuel rail pressure table 175 generates the fuel pressure control signal 53, which is associated with a preferred fuel rail pressure for the base fueling command 137 at the present engine speed 25. The fuel rail pressure table is developed using the engine 10 operating with 0% BV diesel fuel and employing calibration processes known to persons having ordinary skill in the art.

FIG. 5-4 schematically shows an embodiment of the boost controller 180 for generating the compressor boost command 39 taking into account the biodiesel blend ratio to control and prevent compressor surge, thus compensating for a reduction in engine torque at low engine speeds and loads with increased biodiesel blend ratio. A boost calibration table 185 generates an initial compressor boost command 39′, which is associated with a preferred compressor boost for the base fueling command 137 at the present engine speed 25. The boost calibration table 185 is developed using the engine 10 operating with 0% BV diesel fuel and employing calibration processes known to persons having ordinary skill in the art.

A surge line function 181 is developed for the intake air compressor system 38, including separating operation of the intake air compressor system 38 into areas of stability and instability. The surge line function 181 is graphically depicted with compressor inlet pressure Pₐ on the y-axis, plotted in relation to engine operation as described herein. The surge line function 181 includes a permissible boost line 182 that divides the compressor operation into a stable area 184 and an unstable area 186. Surging occurs when the compressor operates in the unstable area 186, and is caused by a decrease of the intake air mass flow rate or an increase of the discharge pressure, i.e., the intake manifold pressure. The term surge describes a cyclic flow and back-flow of compressed intake air accompanied by high vibrations, pressure shocks and rapid temperature increase in the compressor. Persistent surging may damage the intake air compressor system 38 or other elements of the engine 10 and shorten the service life thereof.

The surge line function 181 is employed to determine a maximum permissible boost pressure P̅ᵢₘ 183, which is a point on the permissible boost line 182 that is determined in relation to present engine operation including an intake air mass flow rate \dot{m}ₐ, an intake air temperature upstream of the compressor Tₐ and compressor inlet pressure Pₐ as follows.

$${\overline{P}}_{im} = {P}_{a} \cdot f ( \frac{{\dot{m}}_{a} \sqrt{{T}_{a}}}{{P}_{a}} ) \qquad [ 1 ]$$

The permissible boost line 182 depicts the maximum permissible boost pressures P̅ᵢₘ 183 for a range of values of compressor inlet pressure Pₐ. As appreciated, the adaptive MAF controller 150 for generating the ETC control signal 15 decreases the intake air mass flow rate \dot{m}ₐ as the biodiesel blend ratio increases, and thus the maximum permissible boost pressure P̅ᵢₘ 183 decreases correspondingly, as indicated by EQ. 1. The maximum permissible boost pressure P̅ᵢₘ 1183 and the initial compressor boost command 39′ are compared, and a minimum of the two pressures is selected as the compressor boost command 39 (187). The compressor boost command 39 is input to a closed-loop control scheme including a PID controller 189 to control the intake air compressor system 38, using compressor inlet pressure Pₐ as feedback. Thus, the operation of the engine takes into account the biodiesel blend ratio of the fuel to control engine operation during ongoing operation in the stable area 184. This process adapts the compressor boost command 39 in response to a change in the biodiesel blend ratio while allowing for compressor surge protection.

The maximum boost pressure P̅ᵢₘ 183 is also compared with the compressor inlet pressure Pₐ (190) to determine a pressure difference (ΔP) 191. The pressure difference (ΔP) 191 is input to a second EGR control scheme 158 that employs a second PID controller 159 to generate an adapted EGR control signal 33′ to control operation of the EGR valve 32 and adjust magnitude of EGR flow under specific circumstances. The purpose of the second EGR control scheme 158 is to increase intake airflow by reducing EGR flow. Such a control scheme may be employed to compensate for a relatively slow response time of the intake air compressor system 38, thus preventing potential for surge in the intake air compressor system 38 due to a change in the biodiesel blend ratio.

FIG. 5-5 schematically shows a portion of a second embodiment of the boost controller 180′ shown with reference to FIG. 5-4, including a second embodiment of the surge line function 181′. The boost controller 180′ may be employed to generate the compressor boost command 39 taking into account compressor surge and the biodiesel blend ratio with some allowance for operation of the intake air compressor system 38 when the operating point of the intake air compressor system 38 is not near the permissible boost line 182.

The permissible boost line 182 depicts the maximum permissible boost pressures P̅ᵢₘ 183 for a range of values of compressor inlet pressure Pₐ as previously shown with reference to FIG. 5.4. Modified permissible boost pressures P̅ᵢₘ 195 are determined in relation to the maximum permissible boost pressure P̅ᵢₘ 183 that is determined in relation to present engine operation including a mass airflow rate \dot{m}ₐ, the inlet air temperature Tₐ, and compressor inlet pressure Pₐ as follows.

$${\overline{\overline{P}}}_{im} = {P}_{a} \cdot f ( \frac{{\dot{m}}_{a} \sqrt{{T}_{a}}}{{P}_{a}} ) - Δ P ( \frac{{\dot{m}}_{a} \sqrt{{T}_{a}}}{{P}_{a}} ) \qquad [ 2 ]$$

Modified line 192 depicts the modified permissible boost pressures P̅ᵢₘ 195 over a range of values of the compressor inlet pressure Pₐ, with an incorporated safety factor represented by ΔP. As is appreciated, the first term of EQ. 2 is the maximum permissible boost pressure P̅ᵢₘ 183. As indicated, the unstable area 186 remains unchanged by the introduction of the modified line 192. The stable area (referenced in FIG. 5-4) is separated into a first stable area 184′ and a second stable area 188.

The first stable area 184′ indicates engine operation wherein the boost pressure Pₘ, is less than the modified permissible boost pressure P̅ᵢₘ 195 calculated using EQ. 2. During ongoing operation of the engine 10 in the first stable area 184′, the operation of the engine is controlled by taking into account the biodiesel blend ratio of the fuel to control engine operation.

The second stable area 188 indicates engine operation wherein the boost pressure P̅ᵢₘ, i.e., MAP 27 is greater than the modified permissible boost pressure P̅ᵢₘ 195 calculated using EQ. 2, but less than the maximum permissible boost pressure P̅ᵢₘ 183. During ongoing operation of the engine 10 in the second stable area 188, the operation of the engine is controlled using the boost controller 180 to generate the compressor boost command 39 using default values for controlling the EGR flowrate and intake air mass without compensating for biodiesel blend ratio of the fuel to control engine operation. This embodiment permits increased boost pressure when the engine is operating near the permissible boost line 182, albeit with a risk of increased engine-out NOx emissions that can be dealt with in the exhaust aftertreatment system.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. Method for operating a compression-ignition engine, comprising controlling an engine fueling, a compressor boost pressure, and an EGR content in a cylinder charge to maintain engine operation in response to a biodiesel blend ratio of a biodiesel fuel blend.

2. The method of claim 1, wherein controlling the engine fueling in the cylinder charge to maintain engine operation in response to the biodiesel blend ratio comprises controlling the engine fueling to maintain engine torque output based on the energy content of the biodiesel fuel blend.

3. The method of claim 1, wherein controlling the engine fueling to maintain engine operation in response to the biodiesel blend ratio comprises:
determining a base fueling command based on an engine torque request;
determining a lower heating value of the biodiesel fuel blend; and
adjusting the base fueling command in relation to the lower heating value of the biodiesel fuel blend.

4. The method of claim 1, wherein controlling the EGR content in the cylinder charge to maintain engine operation in response to the biodiesel blend ratio comprises controlling the EGR content in the cylinder charge to maintain exhaust emissions levels based on the oxygen content of the biodiesel fuel blend.

5. The method of claim 4, wherein controlling the EGR content in the cylinder charge to maintain engine operation in response to the biodiesel blend ratio comprises:
determining a ratio of stoichiometric air/fuel combustion for the biodiesel fuel blend; and
adjusting EGR content in the cylinder charge based on the ratio of stoichiometric air/fuel combustion for the biodiesel fuel blend.

6. The method of claim 5, wherein adjusting EGR content in the cylinder charge based on the ratio of stoichiometric air/fuel combustion for the biodiesel fuel blend comprises decreasing the EGR content in the cylinder charge in response to an increase in the ratio of stoichiometric air/fuel combustion for the biodiesel fuel blend.

7. The method of claim 4, wherein controlling the EGR content in the cylinder charge to maintain engine operation in response to the biodiesel blend ratio comprises decreasing the EGR content in the cylinder charge in response to an increase in the biodiesel blend ratio.

8. The method of claim 1, further comprising controlling an engine mass airflow in response to the biodiesel blend ratio.

9. The method of claim 8, wherein controlling the engine mass airflow in response to the biodiesel blend ratio comprises:
determining a ratio of stoichiometric air/fuel combustion for the biodiesel fuel blend; and
adjusting the engine mass airflow based on the ratio of stoichiometric air/fuel combustion for the biodiesel fuel blend.

10. The method of claim 9, wherein adjusting the engine mass airflow based on the ratio of stoichiometric air/fuel combustion for the biodiesel fuel blend comprises decreasing the engine mass airflow in response to an increase in the ratio of stoichiometric air/fuel combustion for the biodiesel fuel blend.

11. The method of claim 8, wherein controlling the engine mass airflow in response to the biodiesel blend ratio comprises decreasing the engine mass airflow in response to an increase in the biodiesel blend ratio.

12. The method of claim 1, wherein controlling the compressor boost pressure to maintain engine operation in response to the biodiesel blend ratio comprises:
determining an initial compressor boost command based on a preferred compressor boost for a base fueling command at a present engine speed;
determining a maximum permissible boost pressure based on a compressor surge line; and
controlling the compressor boost pressure based on a minimum one of the maximum permissible boost pressure and the initial compressor boost command.

13. The method of claim 1, wherein controlling the compressor boost pressure to maintain engine operation in response to the biodiesel blend ratio comprises:
determining an initial compressor boost command based on a preferred compressor boost for a base fueling command at a present engine speed;
determining a first stable area and a second stable area, wherein the first stable area is associated with engine operation when the boost pressure is less than a modified permissible boost pressure, and the second stable area is associated with engine operation when the boost pressure is between the modified permissible boost pressure and a maximum permissible boost pressure based on a compressor surge line; and
controlling operation of the engine based on the biodiesel blend ratio during engine operation in the first stable area and controlling operation of the engine without accounting for the biodiesel blend ratio during engine operation in the second stable area.

14. The method of claim 13, wherein controlling operation of the engine without accounting for the biodiesel blend ratio during engine operation in the second stable area comprises generating a compressor boost command using default values for controlling EGR flowrate and intake air mass without compensating for the biodiesel blend ratio.

15. The method of claim 14, wherein generating a compressor boost command using default values for controlling EGR flowrate and intake air mass without compensating for the biodiesel blend ratio comprises increasing compressor boost pressure when the engine is operating near the maximum permissible boost pressure.

16. Method for operating an internal combustion engine employing a biodiesel fuel blend, comprising:
determining a nominal fueling command in response to an engine torque request;
determining a biodiesel blend ratio of the biodiesel fuel blend;
adjusting the nominal fueling command based upon a heating value of the biodiesel fuel blend;
controlling a compressor boost command based on the nominal fueling command;
controlling a fuel rail pressure command based on the nominal fueling command; and
controlling an EGR command and a mass airflow command based on the biodiesel blend ratio.

17. The method of claim 16, wherein controlling the EGR command and the mass airflow command based on the biodiesel blend ratio comprises:
determining a ratio of stoichiometric air/fuel combustion for the biodiesel fuel blend;
adjusting EGR content in the cylinder charge based on the ratio of stoichiometric air/fuel combustion; and
adjusting the mass airflow command based on the ratio of stoichiometric air/fuel combustion.
